(19) United States
(12) Patent Application Publication
(10) Pub. No.: US 2024/0227650 A1
(43) Pub. Date: Jul. 11, 2024

(54) VEHICLE FLOOR MAT AND LIQUID ABSORBING COMPONENT

(71) Applicant: Wegoluck Co., Ltd., Taipei City (TW)

(72) Inventor: Chiung-Yu Tseng, Tainan City (TW)

(73) Assignee: Wegoluck Co., Ltd., Taipei City (TW)

(21) Appl. No.: 18/094,963

(22) Filed: Jan. 9, 2023

(51) Int. Cl. B60N 3/04; B32B 3/06; B32B 3/26; B32B 3/30; B32B 5/06; B32B 5/26; B32B 7/02; B32B 7/06; B32B 37/18; B32B 38/00

(52) U.S. Cl. CPC B60N 3/048; B32B 3/06; B32B 3/266; B32B 3/30; B32B 5/073; B32B 5/26; B32B 7/02; B32B 7/06; B32B 37/18; B32B 38/145; B32B 2250/02; B32B 2250/20; B32B 2305/18; B32B 2307/726; B32B 2307/7265; B32B 2307/73; B32B 2307/732; B32B 2605/003

(57) ABSTRACT

A vehicle floor mat includes a mat body and a liquid absorbing component. The mat body has a liquid cut off area. The liquid absorbing component is assembled with the mat body in a detachable manner. The liquid absorbing component includes a first liquid absorbing layer and a liquid isolating layer. The liquid isolating layer is disposed on the first liquid absorbing layer. The first liquid absorbing layer being adapted to cover the liquid cut off area, and the liquid isolating layer being a treading area of the vehicle floor mat. The mat body is a flat floor mat made of hydrophobic material, or a three dimensional floor mat made of the hydrophobic material.

### BACKGROUND OF THE INVENTION

### 1. Field of the Invention

The present invention relates to a vehicle floor mat and a liquid absorbing component, and more particularly, to a vehicle floor mat having a detachable absorption element and a related liquid absorbing component.

### 2. Description of the Prior Art

A conventional vehicle floor mat disposes protrusions on a mat surface, and the protrusions may be blocks, strips, or any possible shapes. Several slots formed between the adjacent protrusions allow flowing of fluids, and slotted directions of the slots may point toward the same or different edges of the conventional vehicle floor mat. When the wet shoe steps on the conventional vehicle floor mat, the fluids on the shoe flow from the protrusions into the slots, and flow to the edge or the specific area of the mat surface along the slotted direction of each slot. However, the fluids still remain on the mat surface. The fluids may flow out of the vehicle floor mat due to the sudden movement of the vehicle, or the user may unintentionally step on the fluids accumulated on the mat surface, so that the conventional vehicle floor mat is inconvenient to use.

### SUMMARY OF THE INVENTION

The present invention provides a vehicle floor mat having a detachable absorption element and a related liquid absorbing component for solving above drawbacks.

According to the claimed invention, a vehicle floor mat includes a mat body and a liquid absorbing component. The mat body has a liquid cut off area. The liquid absorbing component is assembled with the mat body in a detachable manner. The liquid absorbing component includes a first liquid absorbing layer and a liquid isolating layer. The liquid isolating layer is disposed on the first liquid absorbing layer. The first liquid absorbing layer being adapted to cover the liquid cut off area, and the liquid isolating layer being a treading area of the vehicle floor mat. The mat body is a flat floor mat made of hydrophobic material, or a three dimensional floor mat made of the hydrophobic material.

According to the claimed invention, the mat body further has a liquid guiding area disposed adjacent to the liquid cut off area, and adapted to guide liquid on the mat body toward the liquid cut off area. A slotted direction of at least one slot structure formed on the liquid guiding area points toward the liquid cut off area, or points toward an area of the mat body excluding the liquid cut off area. The mat body further has a liquid blocking area disposed around the liquid cut off area, or disposed around the liquid cut off area and the liquid guiding area.

According to the claimed invention, the mat body further has a hook-typed fabric layer adapted to assemble with the first liquid absorbing layer of the liquid absorbing component for forming a temporarily fastened state.

According to the claimed invention, a dimension of the liquid absorbing component is smaller than or equal to 35 percent of a dimension of the mat body. The liquid absorbing component is disposed on a range around an end point of a liquid guiding direction of the mat body. The mat body includes a first end and a second end opposite to each other. The liquid absorbing component is disposed on the first end, or disposed on the second end, or disposed between the first end and the second end.

According to the claimed invention, the first liquid absorbing layer of the liquid absorbing component has a loop-typed fabric layer adapted to assemble with a hook-typed fabric layer of the mat body for forming a temporarily fastened state.

According to the claimed invention, a surface of the liquid isolating layer opposite to the first liquid absorbing layer is a printing area of the vehicle floor mat. A plurality of piercing holes is formed on the liquid isolating layer. The liquid absorbing component further includes a second liquid absorbing layer disposed on a surface of the liquid isolating layer opposite to the first liquid absorbing layer.

According to the claimed invention, a liquid absorbing component is applied for a mat body of a vehicle floor mat. The liquid absorbing component includes a first liquid absorbing layer and a liquid isolating layer. The first liquid absorbing layer is adapted to cover a liquid cut off area of the mat body. The liquid isolating layer is disposed on the first liquid absorbing layer.

The vehicle floor mat of the present invention can include the mat body made of the hydrophobic material, and the liquid absorbing component having a liquid absorbing function. The mat body can be at least divided into the liquid cut off area and the liquid guiding area; the liquid cut off area has the hook-typed fabric layer, and the slot structures are optionally disposed on the liquid guiding area. The liquid cut off area can be located on an end point of a liquid guiding direction of the mat body, such as the first end and/or the second end of the mat body. The liquid absorbing component can be disposed on a range around the end point of the liquid guiding direction. Comparing to the prior art, the vehicle floor mat of the present invention can provide the liquid absorbing component which includes the liquid absorbing layer and the liquid isolating layer; the liquid absorbing layer can be used to absorb the accumulated liquid on the mat body, and the liquid isolating layer can be used to avoid the user directly steps on the liquid absorbing layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a vehicle floor mat according to a first embodiment of the present invention.

FIG. 2 is an assembly diagram of the vehicle floor mat according to the first embodiment of the present invention.

FIG. 3 is an enlarged diagram of the vehicle floor mat according to the first embodiment of the present invention.

FIG. 4 is a diagram of the vehicle floor mat according to a second embodiment of the present invention.

FIG. 5 is a diagram of the vehicle floor mat according to a third embodiment of the present invention.

FIG. 6 is a diagram of the vehicle floor mat according to a fourth embodiment of the present invention.

FIG. 7 is a diagram of a liquid absorbing component according to another embodiment of the present invention.

FIG. 8 is a diagram of the liquid absorbing component according to another embodiment of the present invention.

### DETAILED DESCRIPTION

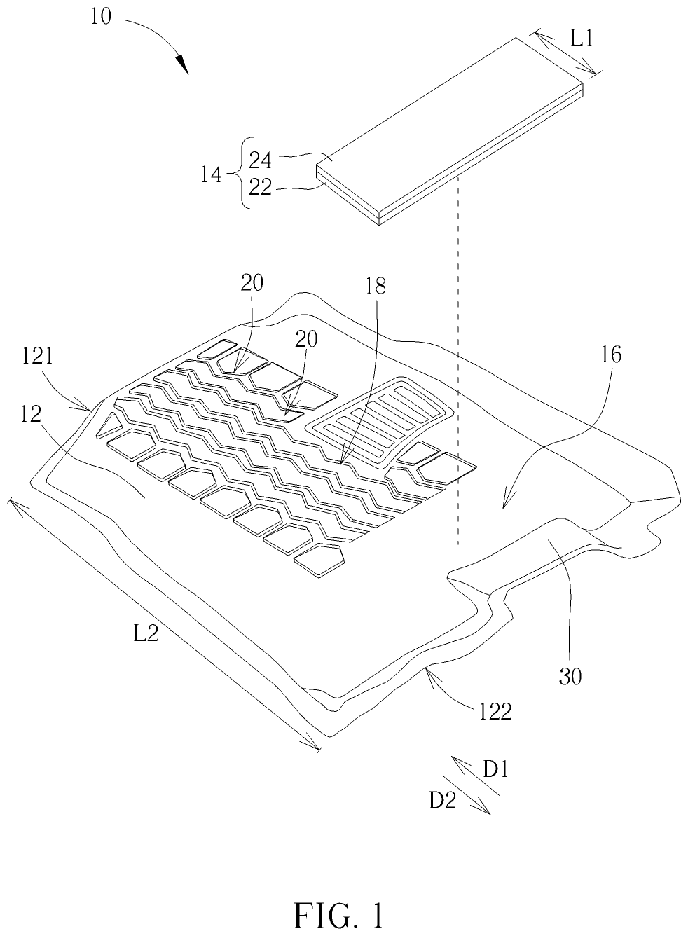

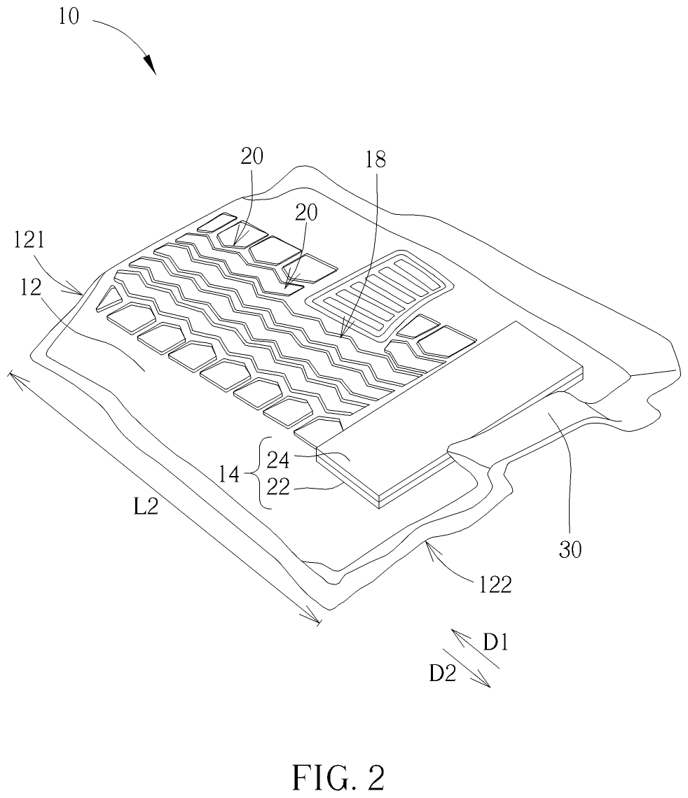

Please refer to FIG. 1 and FIG. 2. FIG. 1 is an exploded diagram of a vehicle floor mat 10 according to a first embodiment of the present invention. FIG. 2 is an assembly diagram of the vehicle floor mat 10 according to the first embodiment of the present invention. The vehicle floor mat 10 can include a mat body 12 and a liquid absorbing component 14. The mat body 12 can be made of hydrophobic material, and put inside the vehicle adjacent to the seat. The liquid absorbing component 14 can be assembled with the mat body 12 in a detachable manner. The liquid accumulated on the mat body 12 can be flowed in a direction opposite to a moving direction D1 of the vehicle, and stayed within a specific end of the mat body 12. For example, the mat body 12 can have a first end 121 and a second end 122 opposite to each other. If the vehicle moves in the moving direction D1, the accumulated liquid on the mat body 12 can be flowed toward the second end 122; if the vehicle moves in the direction opposite to the moving direction D1, the accumulated liquid on the mat body 12 can be flowed toward the first end 121.

Therefore, the mat body 12 can at least include a liquid cut off area 16, and optionally include a liquid guiding area 18. The liquid cut off area 16 can be interpreted as an upper bottom surface of the mat body 12, or as a lowest plane of the mat body 12. If the vehicle moves in the moving direction D1, the liquid cut off area 16 can be located on the second end 122 of the mat body 12, and the liquid cut off area 16 is a liquid gathering area of the mat body 12. The liquid guiding area 18 can be directly disposed by the liquid cut off area 16, or can be slightly distant from the liquid cut off area 16. The accumulated liquid on the mat body 12 can be flowed from the liquid guiding area 18 to the liquid cut off area 16. In the first embodiment, the liquid guiding area 18 of the mat body 12 can include one or a plurality of slot structures 20. The slot structures 20 can be disposed on an area of the mat body 12 where the liquid cut off area 16 is not contained; definition of the liquid cut off area 16 and the liquid guiding area 18 can depend on an actual demand. For example, the liquid guiding area 18 may be a flat area without the slot structure 20, and the accumulated liquid on the mat body 12 can be still flowed toward the liquid cut off area 16 in response to a movement of the vehicle.

In the first embodiment, the slotted direction D2 of the slot structure 20 can point toward the liquid cut off area 16. The slot structure 20 can be, but not limited to, designed as a straight slot or a zigzagged slot. As shown in FIG. 1 and FIG. 2, the slot structure 20 can optionally include one or several angled sections; any type of the slot structure 20 with the slotted direction D2 capable of guiding the accumulated liquid from the first end 121 to the second end 122 can belong to a design scope of the present invention. Besides, the liquid absorbing component 14 can be disposed on the liquid cut off area 16. The liquid absorbing component 14 can include a first liquid absorbing layer 22 or a liquid isolating layer 24. The liquid isolating layer 24 can be disposed on the first liquid absorbing layer 22. The first liquid absorbing layer 22 may be directly attached to the liquid cut off area 16, or may be suspend above the liquid cut off area 16. The liquid absorbing component 14 can conform to the design scope of the present invention as long as the first liquid absorbing layer 22 can cover the liquid cut off area 16 to absorb the accumulated liquid on the liquid cut off area 16. The liquid isolating layer 24 can be a treading area of the liquid absorbing component 14 of the vehicle floor mat 10; the liquid guiding area 18 can further be the treading area of the mat body 12 of the vehicle floor mat 10.

It should be mentioned that a dimension of the liquid absorbing component 14 can be preferably smaller than or equal to 35 percent of a dimension of the mat body 12. For example, a lateral length L1 of the liquid absorbing component 14 can be smaller than or equal to 35 percent of a lateral length L2 of the mat body 12. A lower surface of the liquid isolating layer 24 can be attached to the first liquid absorbing layer 22, and an upper surface of the liquid isolating layer 24 opposite to the first liquid absorbing layer 22 can be a printing area of the vehicle floor mat 10, such as printing the logo of the floor mat 10 or the vehicle, which depends on the actual demand, and the detailed description is omitted herein for simplicity.

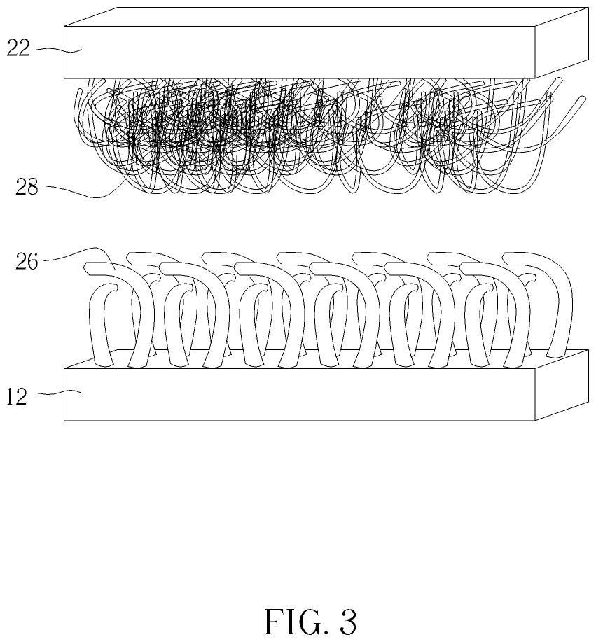

Please refer to FIG. 1 to FIG. 3. FIG. 3 is an enlarged diagram of the vehicle floor mat 10 according to the first embodiment of the present invention. The upper bottom surface of the mat body 12 can include a hook-typed fabric layer 26, and the first liquid absorbing layer 22 can include or be a loop-typed fabric layer 28. When the hook-typed fabric layer 26 contacts the loop-typed fabric layer 28, the mat body 12 and the liquid absorbing component 14 can be assembled to provide a temporarily fastened state. For disassembly of the liquid absorbing component 14 and the mat body 12, the liquid absorbing component 14 can be pulled to separate from the mat body 12. Generally, the hook-typed fabric layer 26 of the mat body 12 can be a prickly surface of the Velcro, or any similar hook tapes; the loop-typed fabric layer 28 of the first liquid absorbing layer 22 can be a woolen surface of the Velcro. Any loop tapes capable of assembling with the hook-typed fabric layer 26 to provide the temporarily fastened state can belong to the design scope of the present invention.

As shown in FIG. 1 and FIG. 2, the vehicle floor mat 10 of the first embodiment can be a three dimensional floor mat, so that mat body 12 can further include a liquid blocking area 30. The liquid blocking area 30 can be optionally disposed around the liquid cut off area 16, or around the liquid cut off area 16 and the liquid guiding area 18. The liquid blocking area 30 can be a surrounding wall of the vehicle floor mat 10. The liquid blocking area 30 can prevent the accumulated liquid on the mat body 12 from leaving the vehicle floor mat 10, and further can guide the accumulated liquid on the mat body 12 toward the liquid cut off area 16. A number, a position and a shape of the liquid blocking area 30 are limited to the embodiment shown in FIG. 1 and FIG. 2, which depends on the design demand, and the detailed description is omitted herein for simplicity.

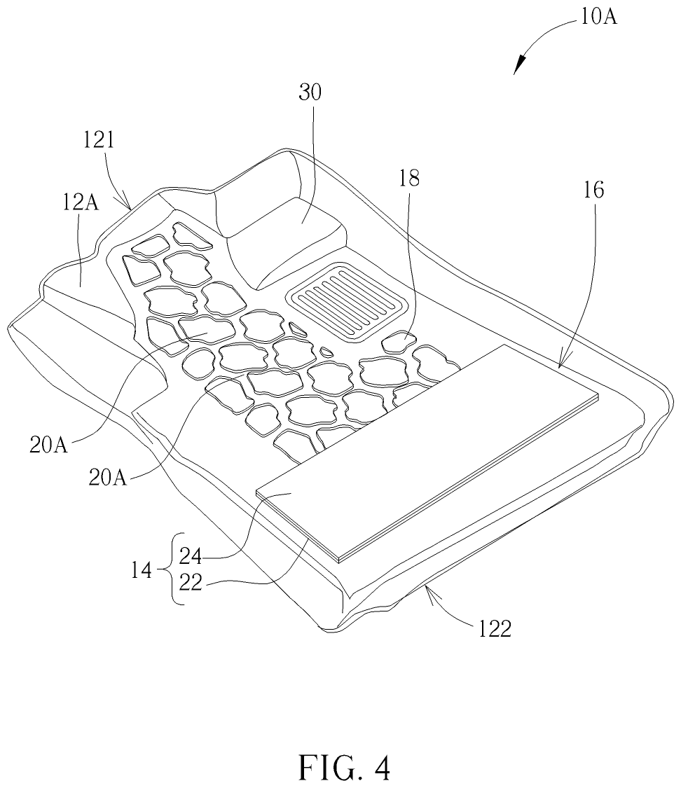

Please refer to FIG. 4. FIG. 4 is a diagram of the vehicle floor mat 10A according to a second embodiment of the present invention. In the second embodiment, elements having the same numerals as ones of the first embodiment have the same structures and functions, and the detailed description is omitted herein for simplicity. In the vehicle floor mat 10 of the first embodiment, the slotted direction D2 of the slot structures 20 can point toward the liquid cut off area 16 in a regular manner. In other possible embodiment, the slot structures 20A of the vehicle floor mat 10A may be designed in an irregular manner. The slotted direction of parts of the slot structure 20A may point toward the liquid cut off area 16, and the slotted direction of other parts of the slot structure 20A may point toward an area of the mat body 12A not belonging to the liquid cut off area 16. When the vehicle moves in the moving direction D1, the accumulated liquid on the mat body 12 can be flowed to the liquid cut off area 16 through the slot structures 20A still, due to inertia effect, for being absorbed by the first liquid absorbing layer 22 of the liquid absorbing component 14.

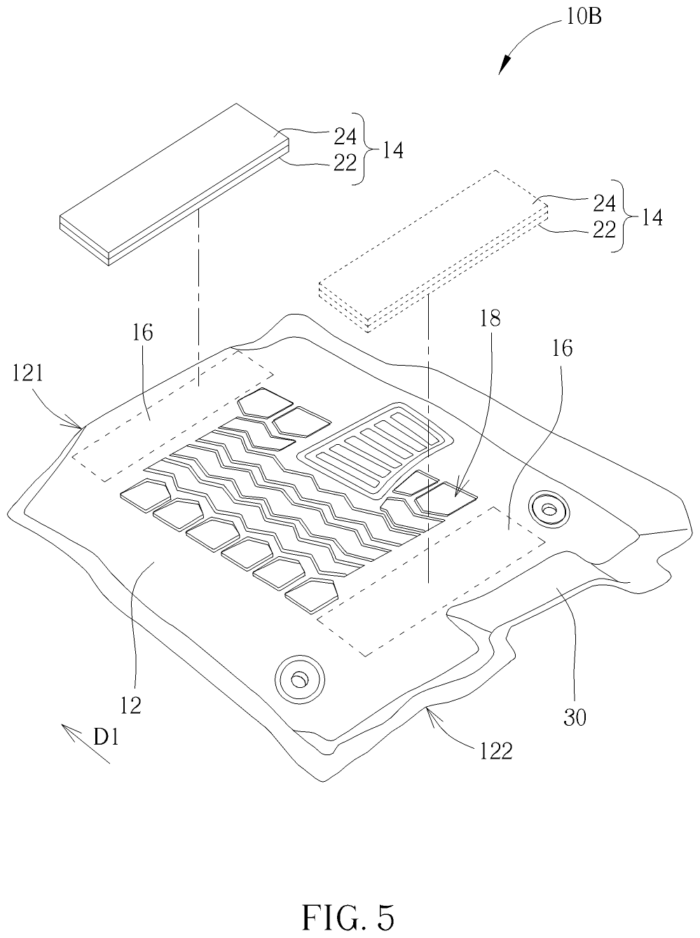

Please refer to FIG. 5. FIG. 5 is a diagram of the vehicle floor mat 10B according to a third embodiment of the present invention. In the third embodiment, elements having the same numerals as ones of the foresaid embodiments have the same structures and functions, and the detailed description is omitted herein for simplicity. The vehicle floor mat 10B can dispose the liquid cut off area 16 optionally on the first end 121 and/or the second end 122 of the mat body 12. When the vehicle moves in the moving direction D1, the accumulated liquid on the mat body 12 can be flowed to the liquid cut off area 16 on the second end 122, so that the foresaid liquid cut off area 16 can be covered by the liquid absorbing component 14. If the vehicle moves in the direction opposite to the moving direction D1, the accumulated liquid on the mat body 12 can be flowed to the liquid cut off area 16 on the first end 121, and therefore the foresaid liquid cut off area 16 can be covered by the liquid absorbing component 14. Moreover, the liquid absorbing component 14 may cover an area between the first end 121 and the second end 122 in accordance with the actual demand. Any specific area on the mat body 12 where the liquid is easily accumulated can be interpreted as the liquid cut off area 16 and be covered by the liquid absorbing component 14.

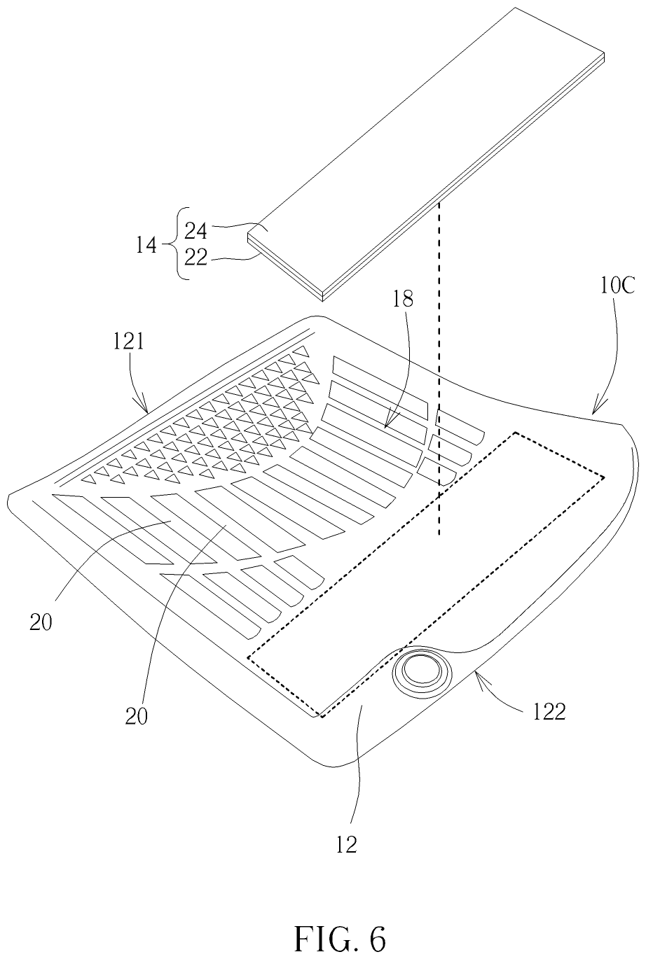

The vehicle floor mats 10, 10A and 10B of the above-mentioned embodiments can be, but not limited to, the three dimensional floor mats. Please refer to FIG. 6. FIG. 6 is a diagram of the vehicle floor mat 10C according to a fourth embodiment of the present invention. In the fourth embodiment, elements having the same numerals as ones of the foresaid embodiments have the same structures and functions, and the detailed description is omitted herein for simplicity. The mat body 12 of the vehicle floor mat 10C does not dispose the surrounding wall around the liquid cut off area 16 or around the liquid cut off area 16 and the liquid guiding area 18, which means the vehicle floor mat 10C can be a flat floor mat. The liquid guiding area 18 of the vehicle floor mat 10C can provide the slot structures 20 designed in the regular manner or in the irregular manner. The liquid cut off area 16 can be disposed on the first end 121 or the second end 122 in accordance with the actual demand of the vehicle floor mat 10C, and be covered by the liquid absorbing component 14. In the fourth embodiment, the liquid cut off area 16 and the related liquid absorbing component 14 are, but not limited to, located on the second end 122 of the mat body 12.

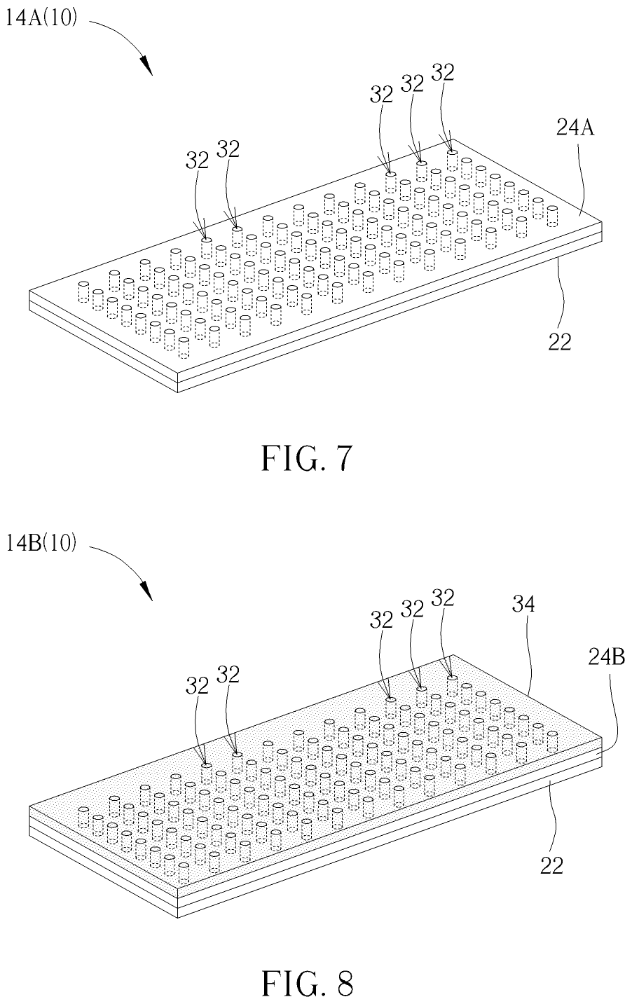

Please refer to FIG. 7. FIG. 7 is a diagram of the liquid absorbing component 14A according to another embodiment of the present invention. The liquid absorbing component 14 in the foresaid embodiments can design the liquid isolating layer 24 as a full flat body, and the full flat body can be set as the treading area and the printing area of the vehicle floor mat 10. The liquid absorbing component 14A in this embodiment can optionally form one or a plurality of piercing holes 32 on the liquid isolating layer 24A. A size, a density and arrangement of the piercing hole 32 cannot be limited to the embodiment shown in the figures, and depends on the design demand. The accumulated liquid may be leaked through the piercing holes 32 when the liquid absorbing component 14A absorbs the accumulated liquid on the mat body 12 and the user steps on the vehicle floor mat 10, so as to remind the user to replace or clean up the liquid absorbing component 14A. The arrangement of the piercing holes 32 may be designed as a specific pattern for artistic appearance.

Please refer to FIG. 8. FIG. 8 is a diagram of the liquid absorbing component 14B according to another embodiment of the present invention. The liquid absorbing component 14B can include the first liquid absorbing layer 22, the liquid isolating layer 24B and a second liquid absorbing layer 34. The first liquid absorbing layer 22 and the second liquid absorbing layer 34 can be respectively disposed on two opposite surfaces of the liquid isolating layer 24B. If the first liquid absorbing layer 22 of the liquid absorbing component 14B absorbs the accumulated liquid on the mat body 12 and the vehicle floor mat 10 is stepped on, the accumulated liquid may be leaked through the piercing hole 32 on the liquid isolating layer 24B, and then be absorbed by the second liquid absorbing layer 34. An upper surface of the second liquid absorbing layer 34 can be used as the treading area and the printing area of the vehicle floor mat 10. This embodiment can increase liquid absorption of the vehicle floor mat 10, so as to reduce a replacement frequency or a removal frequency of the liquid absorbing component 14B.

In conclusion, the vehicle floor mat of the present invention can include the mat body made of the hydrophobic material, and the liquid absorbing component having a liquid absorbing function. The mat body can be at least divided into the liquid cut off area and the liquid guiding area; the liquid cut off area has the hook-typed fabric layer, and the slot structures are optionally disposed on the liquid guiding area. The liquid cut off area can be located on an end point of a liquid guiding direction of the mat body, such as the first end and/or the second end of the mat body. The liquid absorbing component can be disposed on a range around the end point of the liquid guiding direction. Comparing to the prior art, the vehicle floor mat of the present invention can provide the liquid absorbing component which includes the liquid absorbing layer and the liquid isolating layer; the liquid absorbing layer can be used to absorb the accumulated liquid on the mat body, and the liquid isolating layer can be used to avoid the user directly steps on the liquid absorbing layer.

Those skilled in the art will readily observe that numerous modifications and alterations of the device and method may be made while retaining the teachings of the invention. Accordingly, the above disclosure should be construed as limited only by the metes and bounds of the appended claims.

1. A vehicle floor mat comprising:
a mat body, having a liquid cut off area; and
a liquid absorbing component assembled with the mat body in a detachable manner, the liquid absorbing component comprising a first liquid absorbing layer and a liquid isolating layer, the liquid isolating layer being disposed on the first liquid absorbing layer, the first liquid absorbing layer being adapted to cover the liquid cut off area, a plurality of piercing holes being formed on the liquid isolating layer for leaking accumulated liquid from the first liquid absorbing layer.

2. The vehicle floor mat of claim 1, wherein the mat body is a flat floor mat made of hydrophobic material, or a three dimensional floor mat made of the hydrophobic material.

3. The vehicle floor mat of claim 1, wherein the mat body further has a liquid guiding area disposed adjacent to the liquid cut off area, and adapted to guide liquid on the mat body toward the liquid cut off area.

4. The vehicle floor mat of claim 3, wherein a slotted direction of at least one slot structure formed on the liquid guiding area points toward the liquid cut off area, or points toward an area of the mat body excluding the liquid cut off area.

5. The vehicle floor mat of claim 3, wherein the mat body further has a liquid blocking area disposed around the liquid cut off area, or disposed around the liquid cut off area and the liquid guiding area.

6. The vehicle floor mat of claim 1, wherein a dimension of the liquid absorbing component is smaller than or equal to 35 percent of a dimension of the mat body.

7. The vehicle floor mat of claim 1, wherein the mat body comprises a first end and a second end opposite to each other, the liquid absorbing component is disposed on the first end, or disposed on the second end, or disposed between the first end and the second end.

8. The vehicle floor mat of claim 1, wherein the first liquid absorbing layer of the liquid absorbing component has a loop-typed fabric layer adapted to assemble with a hook-typed fabric layer of the mat body for forming a temporarily fastened state.

9. The vehicle floor mat of claim 1, wherein the liquid isolating layer is a treading area of the vehicle floor mat.

10. The vehicle floor mat of claim 1, wherein a surface of the liquid isolating layer opposite to the first liquid absorbing layer is a printing area of the vehicle floor mat.

11. (canceled)

12. The vehicle floor mat of claim 1, wherein the liquid absorbing component further comprises a second liquid absorbing layer disposed on a surface of the liquid isolating layer opposite to the first liquid absorbing layer.

13. A liquid absorbing component applied for a mat body of a vehicle floor mat, the liquid absorbing component comprising:
a first liquid absorbing layer adapted to cover a part of the mat body; and
a liquid isolating layer disposed on the first liquid absorbing layer, a plurality of piercing holes being formed on the liquid isolating layer for leaking accumulated liquid from the first liquid absorbing layer.

14. The liquid absorbing component of claim 13, wherein a dimension of the liquid absorbing component is smaller than or equal to 35 percent of a dimension of the mat body.

15. The liquid absorbing component of claim 13, wherein the mat body comprises a first end and a second end opposite to each other, the liquid absorbing component is disposed on the first end, or disposed on the second end, or disposed between the first end and the second end.

16. The liquid absorbing component of claim 13, wherein the first liquid absorbing layer of the liquid absorbing component has a loop-typed fabric layer adapted to assemble with a hook-typed fabric layer of the mat body for forming a temporarily fastened state.

17. The liquid absorbing component of claim 13, wherein the liquid isolating layer is a treading area of the vehicle floor mat.

18. The liquid absorbing component of claim 13, wherein a surface of the liquid isolating layer opposite to the first liquid absorbing layer is a printing area of the vehicle floor mat.

19. (canceled)

20. The liquid absorbing component of claim 13, wherein the liquid absorbing component further comprises a second liquid absorbing layer disposed on a surface of the liquid isolating layer opposite to the first liquid absorbing layer.
